(19) United States
(12) Patent Application Publication
(10) Pub. No.: US 2013/0216015 A1
(43) Pub. Date: Aug. 22, 2013

(54) INTEGRATED SODIUM-COOLED FAST NUCLEAR REACTOR

(71) Applicant: Guy-Marie Gautier, Pertuis (FR)

(72) Inventor: Guy-Marie Gautier, Pertuis (FR)

(73) Assignee: COMMISSARIAT A L'ENERGIE ATOMIQUE ET AUX ENERGIES ALTERNATIVES, Paris (FR)

(21) Appl. No.: 13/877,906

(22) PCT Filed: Oct. 3, 2011
(86) PCT No.: PCT/EP2011/067206

§ 371 Date: May 7, 2013

(30) Foreign Application Priority Data
Oct. 4, 2010 (FR) 10 58016

(51) Int. Cl. G21C 1/32; G21C 15/247

(52) U.S. Cl. CPC G21C 1/322; G21C 15/247
USPC 376/211

(57) ABSTRACT

An improvement to an SFR reactor of the integrated type wherein each of the outlet windows of the intermediate exchangers is surrounded in an enclosure in fluid communication with a pipe shaped into a toroid; and each of the inlets of the pump group which pumps the sodium from the hot area to the cold area through the intermediate exchangers is also in fluid communication with the toroid, such that the primary sodium originating from the hot area and exiting from the intermediate exchangers flows through the toroid and is then directed to the cold area by the said pump group.

### TECHNICAL FIELD

The invention relates to an SFR sodium-cooled nuclear reactor (Sodium Fast Reactor) belonging to the family of reactors known as fourth-generation reactors.

More specifically, the invention relates to a sodium-cooled nuclear reactor of the integrated type, in other words in which the primary circuit is fully contained in a vessel also containing the primary pumps and heat exchangers.

The invention proposes an improvement to application WO 2010/057720, which proposed an innovative architecture of the primary circuit contained in the vessel of the reactor making it possible to improve its compactness, to facilitate the design of certain parts and to improve the natural convection of sodium in the vessel.

### STATE OF THE PRIOR ART

Sodium-cooled fast reactors (SFR) normally comprise a vessel in which is placed the core with, above the core, a core control plug. The discharge of heat takes place by circulating sodium, known as primary sodium, by means of a pumping system placed inside the vessel. This heat is transferred to an intermediate circuit, via one or more intermediate exchanger(s) (EI), before being used to produce steam in a steam generator (GV). This steam is then sent into a turbine to transform it into mechanical energy, in its turn transformed into electrical energy.

The intermediate circuit comprises sodium as heat conveying medium and has the purpose of isolating (or in other words containing) the primary sodium that is in the vessel, in relation to the steam generator, on account of the violent reactions capable of occurring between sodium and the water-steam contained in the steam generator in the event of any rupture of a tube of said generator. Thus, the architecture puts an emphasis on two sodium circuits: one known as primary, charged with transferring the heat between the core and one or more intermediate heat exchanger(s), the other known as secondary charged with transferring the heat from the intermediate exchanger(s) to the steam generator.

All sodium-cooled fast reactors (SFR) have common technical characteristics. The vessel is closed off on the top by a covering slab in order that the primary sodium is not in contact with the external air.

All of the components (exchangers, pumps, pipes, etc.) pass through this slab vertically to be able to be dismantled by lifting them vertically with a lifting device. The dimensions of the through holes in this slab depend on the size and the number of components. The larger the dimensions of the holes and the greater their number, the larger the diameter of the vessel.

The different technical solutions retained to date may be classified into two major families of reactors: loop type reactors and integrated type reactors.

SFR loop type reactors are characterised by the fact that the intermediate exchanger and the devices for pumping the primary sodium are situated outside of the vessel.

The main advantage of a SFR loop type reactor is, for a given power, to obtain a vessel of smaller diameter than that of a SFR reactor of integrated type, because the vessel contains fewer components. The vessel is thus easier to manufacture and thus less expensive. On the other hand, a SFR loop type reactor has the major drawback of making the primary sodium come out of the vessel, which complicates the primary circuit architecture and poses important safety problems. Thus, the advantages linked to the reduced size and the easier manufacture of the vessel are cancelled by the extra costs induced by the addition of devices linked to the design of the loops and special means to manage any leaks of primary sodium.

SFR reactors of integrated type are characterised by the fact that the intermediate exchangers and the pumping means of the primary sodium are fully situated in the vessel, which makes it possible to avoid having the primary circuit go outside the vessel and thus constitutes an important advantage in terms of safety compared to an SFR loop type reactor.

The inventors of the present application proposed in application WO 2010/057720 a solution seeking to improve SFR reactors of the integrated type.

More specifically, the aim of the solution they proposed is to resolve the disadvantages of SFR reactors of the integrated type which they had identified as follows:

a difficult design and realisation of the step between the hot collector and cold collector,

a delicate compatibility between normal operation under forced convection and operation under natural convection of the discharge of the residual power when the electromechanical pumps are malfunctioning,

a large size of vessel, which penalises the concept from an economical point of view.

The solution according to application WO 2010/057720 is not completely satisfactory. Indeed, placing a group of pumping means next to each intermediate exchanger (upstream or downstream), i.e. the exchanger the task of which is to circulate the sodium from the hot area to the cold area traversing the intermediate exchangers, implies spatial constraints.

These spatial constraints may impair the reactor's compactness, which in tangible terms would lead to an increase of the size of the reactor vessel.

Another disadvantage of the solution according to WO 2010/057720 is that placing a group of pumping means next to, and downstream from, the intermediate exchangers may complicate installation of the SFR reactor. Indeed, in this case the pumping means are to some extent positioned at the end of the intermediate exchanger, and may constitute an unbalance, which can impair the mechanical properties in the event of seisms.

The aim of the invention is therefore to propose an improvement of the SFR reactor of the integrated type, and according to application WO 2010/057720, which seeks to compensate for all or part of its disadvantages mentioned above.

### DESCRIPTION OF THE INVENTION

According to the invention, this objective is attained by an SFR nuclear reactor of the integrated type, comprising a vessel adapted to be filled with sodium and inside of which are provided a core, pumping means for the flow of the primary sodium, first heat exchangers, known as intermediate exchangers, adapted to discharge the power produced by the core during normal operation, second heat exchangers adapted to discharge the residual power produced by the core while stopped when the pumping means are also stopped, a separation device defining a hot area and a cold area in the vessel, including:

a separation device constituted of two walls each with a substantially vertical portion provided surrounding the core and a substantially horizontal portion, the substantially horizontal portions being separated from each other by a height and the space defined above the horizontal portion of the upper wall forming the hot area whereas the space defined below the horizontal portion of the lower wall forms the cold area and the substantially horizontal portions are provided with clearances in relation to the vessel,

intermediate exchangers arranged substantially vertically with clearances in first cuts made in each horizontal portion of the wall of the separation device so as to localise their outlet windows below the horizontal portion of the lower wall,

pumping means with variable flow divided into two groups hydraulically in series, one provided below the horizontal portion of the lower wall for the flow of the sodium from the cold area to the hot area through the core, the other to pump the sodium from the hot area to the cold area through the intermediate exchangers,

temperature acquisition means provided in the space defined between the horizontal portions of the two walls in being spread out according to a substantially vertical axis to determine in real time the thermal stratification in this space,

automatic control means connected on the one hand to the temperature acquisition means and on the other hand to the two pump groups, to modify if necessary the flow of at least one pump group in order to maintain a satisfactory level of stratification during normal operation,

second exchangers arranged substantially vertically above the cold area,

means to enable the natural convection of the primary sodium from the second exchangers to the cold area when the core and the pumping means are also stopped,

a reactor in which of the clearances and the height between the horizontal portions of the two walls of the separation device are previously determined so as to, during normal operation, take up differential movements between the walls, exchangers and vessel and to make it possible to establish during normal operation a thermal stratification of the primary sodium in the space defined between the horizontal portions of the two walls and to reduce, in case of an unexpected stop of a single pump group, the mechanical stress applied to the walls and due to the portion of the primary sodium flow passing between said clearances.

According to the invention,

each of the outlet windows of the intermediate exchangers is surrounded in an enclosure in fluid communication with a pipe shaped into a toroid,

each of the inlets of the pump group which pumps the sodium from the hot area to the cold area through the intermediate exchangers is also in fluid communication with the toroid, such that the primary sodium originating from the hot area and exiting from the intermediate exchangers flows through the toroid and is then directed to the cold area by the said pump group.

Compared to the solution according to application WO 2010/057720, the need to produce a new mixed design of intermediate exchangers with the group of pumping means next to them is avoided. As a corollary, intermediate exchangers having previously been approved for SFR reactors of the integrated type according to the state of the art may be used in an SFR reactor of the integrated type according to the invention. In addition, since the pumping means are no longer attached at the outlet of the intermediate exchanger, the additional mass at the lower end of the intermediate exchanger, which is likely to create an unbalance, no longer exists, which is favourable for the intermediate exchanger's mechanical properties in the event of a seism. Depending on the flow conditions desired in the toroid, the number of pumping means, and their characteristics, such as flow rate, pressure, etc., may be adjusted. In addition, by virtue of the toroid pipe according to the invention, the flow of the primary sodium through all the intermediate exchangers can be homogenised more easily than with the solution according to application WO 2010/057720.

According to one embodiment, the variable flow rate pump groups in hydraulic series are mechanically independent of one another, and each consists of rotodynamic pumps, the drive shaft of which extends vertically over the entire height of the vessel, traversing the covering slab and the horizontal portions of both walls of the separation device, which are arranged appreciably vertically with clearances, where the clearances between the structure supporting the pumps and both walls of the separation device are also determined beforehand such that, in normal operation, they take up the differential displacements between them and the vessel, and to enable thermal stratification of the primary sodium to be established in normal operation in the space defined between the horizontal portions of both walls and, in the event of an untimely stoppage of a pump group, to limit the mechanical forces which are applied to the walls, due to the proportion of the primary sodium flow passing through the said clearances.

According to one advantageous embodiment, the two variable flow rate pump groups in hydraulic series are mechanically dependent, and consist of at least one double-impeller centrifugal rotodynamic pump, a first impeller of which positioned with its inlet to suck up the primary sodium axially into the toroid, and with its outlet to drive the primary sodium into the cold area, and the second impeller, installed on the same drive shaft line as the first impeller, and positioned with its inlet to suck up the primary sodium into the cold area, and its outlet to drive it towards the core. Coupling both impellers described above on the same shaft line signifies that the flow of primary sodium traversing the core, and the flow of primary sodium traversing the intermediate exchangers can be varied in a similar fashion, notably at the intermediate flow rates. This also has the advantage that it simplifies the method of control and adjustment of the flow rates. Finally, this combination enables the number of components in the vessel to be reduced, and thus enables the vessel to be made more compact. In addition, compared to the embodiment in which both pump groups are mechanically independent, in this case it is not necessary to define a clearance between the supporting structure of the pumps and the walls of the separation device which takes account of the additional mechanical forces on the latter in the event that a double-impeller pump group stops. Indeed, in such a case, the average flow rate through the separation device, i.e. between both its walls, is zero, and there are therefore no prejudicial mechanical forces on them.

Such an adaptation of a double-impeller centrifugal rotodynamic pump is far from having been obvious. Indeed, although pumps of this type with two impellers supported by a single shaft are known, they habitually operate to increase the pressure of one wheel on the other, and therefore with the suction inlet of a wheel or impeller corresponding to the suction outlet of another wheel or impeller installed in series. This is, moreover, the reason why their habitual technical designation is a “multi-stage pump”. The double-impeller centrifugal pump according to the invention is distinguished from those known in the state of the art by the fact that there is an intermediate area of a large volume between both impellers of a given pump, and in that this intermediate area is common to several pumps. This large-volume intermediate area is the cold area of the reactor according to the invention. In other words, in this case, unlike the multi-stage pumps according to the state of the art, the pressure ratios of the stages are added together, each of the stages being constituted by an impeller, but not necessarily with the same flow rate, since the intermediate volume is in hydraulic communication with other elements of the reactors, for example via the cuts of the step. Thus, during normal reactor operation, the flow rate traversing the intermediate exchangers and the flow rate traversing the core is the same, and is therefore identical in both impellers. As in a conventional two-stage pump, therefore, the pressures are always added together, but the fact that there is a large volume between both impellers, constituted by the cold collector, implies that there is filtering, i.e. an alleviation of any thermal impact which may occur if an operating failure occurs. If, for example, the sodium exiting intermediate exchangers EI and, when it arrives, is not sufficiently cold, but suddenly becomes cold following an untimely shutdown of the heat extraction system of the secondary side of the intermediate exchanger, the pump's first impeller (the one which sucks fluid up into the toroid) is therefore to some extent subject to this thermal impact, but the second impeller experiences a gradual rise of temperature of the sodium, since the hot sodium exiting the first impeller is gradually blended with the cold sodium already present in the cold collector.

Another operational difference of the double-impeller pump according to the invention, compared to conventional two-stage pumps, is the operating mode in residual power removal mode. In a conventional two-stage pump the same flow traverses the pump's impellers, even if the pump is stopped (with the flow occurring by natural convection, for example). In the case of the present invention, in a residual power removal situation, it may be that no flow is traversing the first impeller (the one which has its inlet in the toroid), whereas the entire flow which traverses the second impeller and which feeds the core is coming from the cold collector. The hydraulic loop is then formed by the following elements: the core, the hot collector, the exchangers dedicated to residual power removal, the cuts in the step, the cold collector, the pump's second impeller, and finally the core. The sodium then flows in this loop by natural convection.

Depending on the reactor's operating conditions, at least one means to adjust the flow rate of primary sodium through the core relative to the flow rate through the intermediate exchangers, independently of one another, and of the speed of rotation of the drive shaft line of both impellers, may advantageously be provided.

This may be the case within a certain variable range of speed of rotation of the drive of independent pumps (not on the same shaft).

It may also arise in the course of the reactor's lifetime. Typically, the envisaged lifetime of a “fourth-generation” reactor is thus several tens of years. During the reactor's lifetime the fuel elements constituting the core are regularly changed. Depending on the nuclear material management context, new types of nuclear fuel elements may be loaded in the reactor core. And these new nuclear fuel elements may lead to different load losses of the fuel elements initially present in the core. In this configuration the inventor believes that it will be difficult to obtain an identical flow rate between the rate traversing the core and the rate traversing the intermediate exchangers with only the initially fitted double-impeller pump. The means of adjusting the flow rate between the core and the intermediate exchangers thus advantageously enables the new introduced load losses to be compensated effectively. By definition this cannot be resolved by modifying the speed of rotation of both impellers, since they are coupled to the same shaft line.

According to one advantageous variant, the means for adjusting the flow rate consist of one/some additional pumping means, separate from the electromechanical pump(s) with two impellers, and the inlet of which is/are in fluid communication with the toroid, where the sum of the flow rates of primary sodium supplied by the additional pumping means and the double-impeller pump are approximately equal to the flow rate traversing the intermediate exchangers.

The value of the flow rate provided by the impeller of the double-impeller pump having its suction in the toroid may preferably be between 90 to 95% that of the flow rate traversing the intermediate exchangers. It is self-evident that the flow supplied by the double-impeller pump may depend on the speed of rotation of the drive shaft line. Thus, depending on the value of the flow rate provided by the double-impeller pump, the additional pumping means supply the additional flow, adjusting it such that the flow rate traversing the intermediate exchangers is equal to that traversing the core. It is preferably ensured that the additional pumping means supply a low flow rate, typically of a value of 5 to 10% of the flow rate traversing the intermediate exchangers.

The additional pumping means are advantageously constituted by a rotodynamic pump and/or an electromagnetic pump.

The advantage of using these pumps is their low required capacity, and therefore the small volume they occupy, which again favours the reactor's compactness.

According to one advantageous variant:

the drive shaft line of the pump's two impellers includes at least two coaxial shafts which are rotationally secured to one another, and which can be displaced axially relative to one another, where the lower end of one of the shafts supports at least a proportion of the impeller's blades, whereas the lower end of the other shaft supports the other portion of the impeller;

the means for adjusting the flow rate consist of the drive shaft, to the lower end of which the proportion (at least) of the impeller's blades are attached, and the axial displacement of which relative to the other drive shaft allows the proportion at least of the blades to be retracted. A double-impeller centrifugal rotodynamic pump is manufactured with hydraulic circulation in an impeller included between two disks. One of these disks is stationary, whereas the other is attached to the impeller supporting the blades. Habitually, to obtain maximum efficiency, a minimum installation clearance is thus allowed between the edges of the blades of the moving disk and the stationary disk. In this case, judiciously, by installing retractable blades in the moving disk, the clearance between them and the stationary disk may be adjusted, and hence the efficiency of the pump, i.e. its flow rate-dependent pressure characteristics, may be degraded to a greater or lesser extent.

For reasons of safety, the mechanism for controlling movement of the shaft allowing the proportion at least of the blades to be retracted is advantageously positioned above the drive motor of the shaft line, which is itself positioned above the covering slab. This embodiment is moreover simpler than an embodiment in which the control mechanism is positioned elsewhere.

An SFR reactor of the integrated type according to the invention may include six intermediate exchangers, six second exchangers, and three double-impeller centrifugal rotodynamic pumps.

### BRIEF DESCRIPTION OF THE ILLUSTRATIONS

Other advantages and characteristics of the invention will become clearer on reading the detailed description of the invention made in reference to the following figures, in which:

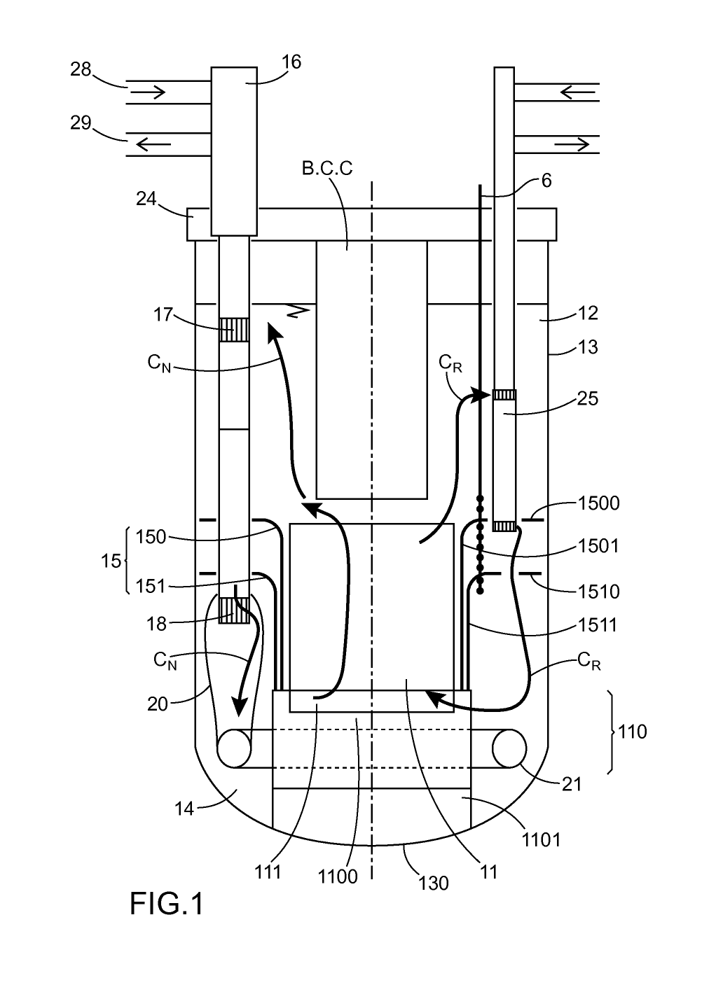

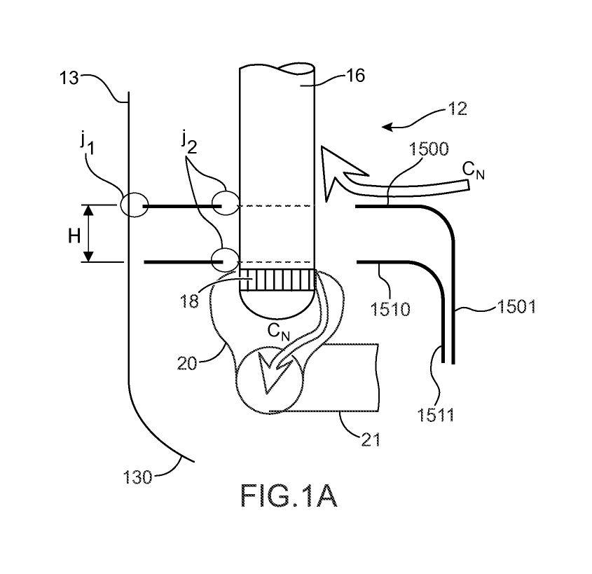

FIG. 1 is a lengthways section schematic view of an SFR reactor of the integrated type according to the invention,

FIG. 1A is a lengthways section partial schematic view of an SFR reactor of the integrated type according to the invention, illustrating a positioning variant between an intermediate exchanger and a shaft shaped into a toroid according to the invention,

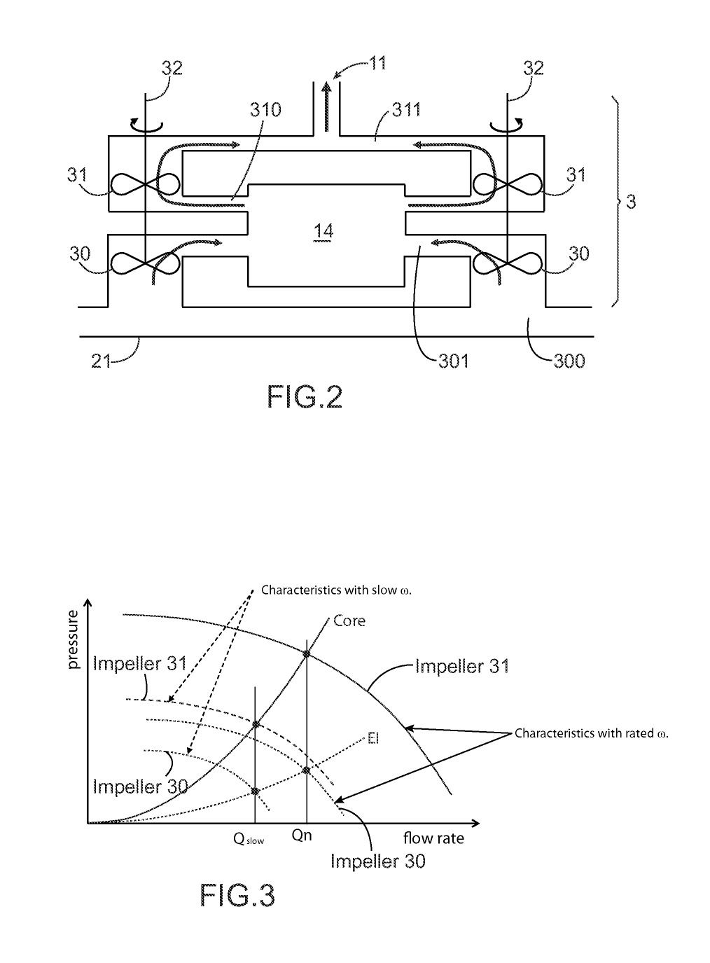

FIG. 2 is a schematic view illustrating a solution for collecting sodium at the outlet of the intermediate exchangers in a toroid, and for pumping sodium according to the invention with, as pumping means, two double-impeller centrifugal pumps,

FIG. 3 shows the characteristic curves of the pressure as a function of the flow rate of a double-impeller centrifugal pump according to the invention,

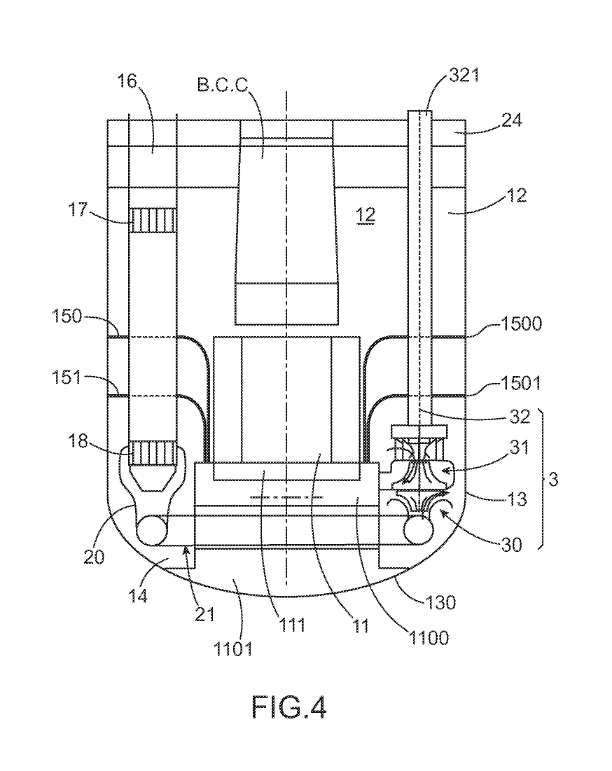

FIG. 4 is another lengthways section schematic view of an SFR reactor of the integrated type according to the invention, in which the positioning of a double-impeller pump is shown,

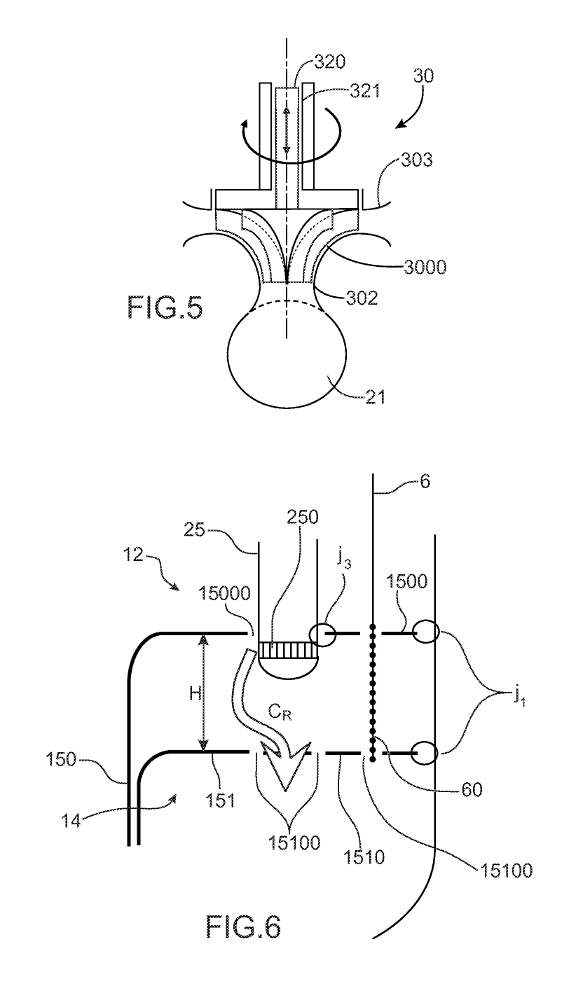

FIG. 5 is a detailed section view of an impeller of the centrifugal pump with a means of adjusting the sodium flow rate,

FIG. 6 is a schematic partial longitudinal sectional view of an SFR reactor of integrated type according to the invention illustrating the relative lay out between exchangers dedicated to the discharge of residual power, temperature acquisition means and separation device between hot area and cold area according to the invention,

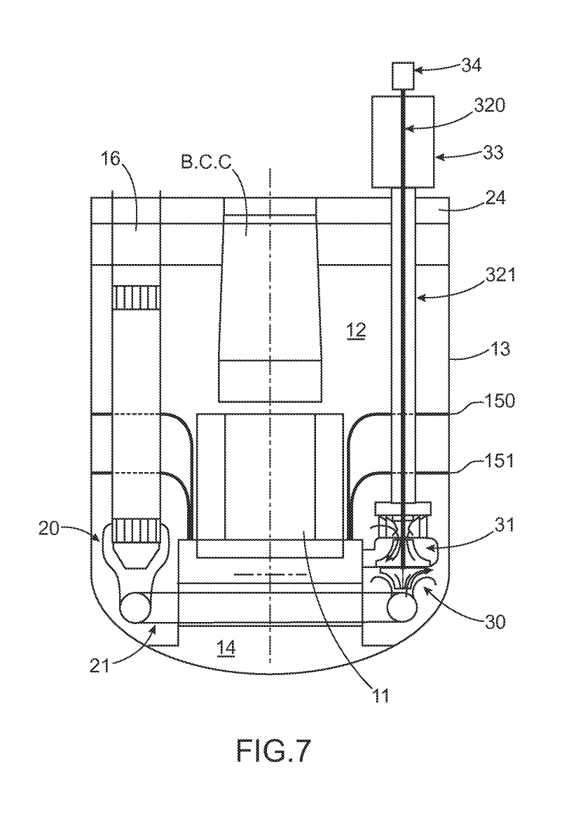

FIG. 7 is another view similar to FIG. 4 in which, in addition to the drive motor, the mechanism for controlling the movement of the blades of an impeller of a pump according to the invention is represented.

### DETAILED ACCOUNT OF PARTICULAR EMBODIMENTS

Throughout the present application, the terms “horizontal”, “vertical”, “lower”, “upper”, “below” and “above” should be understood with reference to a vessel of the reactor arranged vertically and to the lay out in relation to the cold or hot area. Thus, the upper wall according to the invention designates the wall the closest to the hot area, whereas the lower wall designates that closest to the cold area. Similarly, a pump according to the invention provided below the lower wall is that situated in the cold area.

Similarly, throughout the present application, the terms “upstream” and “downstream” should be understood with reference to the direction of the flow of sodium. Thus, a group of pumping means upstream of an intermediate exchanger is traversed firstly by the sodium which then flows through the intermediate exchanger. A group of pumping means downstream of an intermediate exchanger is traversed by the sodium which has passed through the intermediate exchanger beforehand.

In FIG. 1 may be seen the overall diagram of an SFR reactor of integrated type according to the invention. The integrated reactor comprises a core 11 in which heat is released following nuclear reactions. Said core 11 is supported by a support 110. This support 110 comprises a diagrid 1100 in which are sunk the bases of assemblies 111 constituting the core, this diagrid 1100 being supported by a decking 1101 resting on the bottom 130 of the vessel 13. Above the core is the core control plug (BCC) comprising the instrumentation necessary for the control and the correct operation of nuclear reactions.

The heat discharge circuit followed by the primary sodium during normal operation of the core 11 is schematically represented by the arrows in solid lines CN: at the outlet of the core, the sodium emerges into a hot collector 12. The hot collector 12 is separated from the cold collector 14 underneath by an appropriate separation device 15.

This separation device between hot 12 and cold 14 collectors (or areas) is constituted of two walls 150, 151 with cuts. These two walls 150, 151 with cuts each have a substantially vertical portion 1501, 1511 provided surrounding the core and a substantially horizontal portion 1500, 1510. The horizontal portions 1500, 1510 are separated by a height H. In the embodiments illustrated, they are connected together by a round off. The vertical portions of each wall 150, 151 are fixed to the core support 110 11. The space defined above the horizontal portion 1500 of the upper wall 150 forms the hot area, whereas the space defined below the horizontal portion 1510 of the lower wall 151 forms the cold area.

As shown in FIGS. 1A and 6, the substantially horizontal portions 1500, 1510 are provided with clearances j1 in relation to the vessel 13.

Each intermediate exchanger 16 is arranged vertically through the covering slab 24. The primary sodium supplying the intermediate exchangers 16 during normal operation is taken from the hot collector 12 and is expelled into the cold collector 14. The intermediate exchangers 16 pass through the two horizontal portions 150, 151 of wall with a functional clearance j2 and without any particular sealing.

In the SFR reactor according to the invention, as in that of application WO 2010/057720, there are variable-flow rate pumping means 3 divided into two groups 30, 31 in hydraulic series. One group, 31, is designed to pump the sodium from cold area 14 towards hot area 12, traversing core 11, and other group 30 is designed to pump the sodium from hot area 12 towards cold area 14, traversing intermediate exchangers 16.

According to the invention, provision is first made to surround each of outlet windows 18 of intermediate exchangers 16 in an enclosure 20 in fluid communication with a shaft shaped into a toroid 21.

Provision is also made for each of the inlets of pump group 30, designed to pump the sodium from hot area 12 to cold area 14, also to be in fluid communication with toroid 21, such that the primary sodium originating from hot area 12 and exiting from intermediate exchangers 16 flows through toroid 21 and is then directed to the cold area by said pump group 30.

As represented in FIG. 2, one advantageous embodiment consists in producing at least one pumping means 3 in common between both groups 30, 31 constituted by a double-impeller centrifugal rotodynamic pump. The first pump group is constituted by impeller 30 of pump 3, and is positioned with its inlet 300 to suck up the primary sodium axially into toroid 21, and with its outlet 301 to drive the primary sodium into cold area 14. The second group is constituted by impeller 31 of the same pump 3 and is installed on the same drive shaft line 32 as first impeller 30, and it is positioned with its inlet 310 to suck up the primary sodium radially into cold area 14, with its outlet 311 to drive it towards core 11.

Coupling both impellers 30, 31 on the same shaft line 21 signifies that the flow of primary sodium traversing core 11, and the flow of primary sodium traversing intermediate exchangers 16, can be varied in a similar fashion, notably at the intermediate flow rates.

This is shown more clearly in FIG. 3, which is a characteristic diagram of the flow rate curves as a function of pressure for both impellers 30, 31 of the same pump 3 with a common area 14. It can be seen that:

for a speed of rotation of shaft line 32 (rated speed ω_{rated} or slow speed ω_{slow}), the curves of impeller 30 and of impeller 31 are almost parallel with one another,

the variation of the flow rate of primary sodium traversing core 11 is equal to the variation of the flow rate of sodium traversing intermediate exchangers 16.

FIG. 4 shows the positioning of a single centrifugal pump with two impellers 30, 31 in the reactor. Supporting structure 321 of the double-impeller pump in which shaft line 32 is located extends vertically appreciably over the entire height of vessel 13, traversing covering slab 24 and horizontal portions 1500, 1501 of both walls 150, 151 of the separation device, which are arranged roughly vertically, with clearances. As explained below, the clearances between supporting structure 321 of the pump in which shaft line 32 of the pump is located, and both walls of the separation device, are previously determined in order that, in normal operation, the differential movements between them and vessel 13 are taken up, and, in normal operation, to allow thermal stratification of the primary sodium to be established in the space defined between the horizontal portions of walls 150, 151. In addition, in this figure, it may be stipulated that the sodium originating from cold collector 14 arrives radially at the inlet of impeller 31 before being sucked up axially by it.

Depending on the reactor's operating conditions, at least one means to adjust the flow rate of primary sodium through core 11 relative to the flow rate through intermediate exchangers 16, independently of one another, and of the speed of rotation of the drive shaft line of both impellers, may advantageously be provided. FIG. 5 shows an advantageous embodiment of such a means. As represented, the drive shaft line includes at least two coaxial shafts 320, 321, able to be moved axially relative to one another.

The lower end of shaft 320 supports the blades, whereas the lower end of other shaft 321 supports the other portion of the impeller which is axially stationary. By moving shaft 320 axially relative to shaft 321, blades 3000 are thus retracted. The clearance between the edges of blades 3000 and stationary disk 302 is thus increased, which enables the pump's efficiency, i.e. its flow rate-dependent pressure characteristics, to be degraded to a greater or lesser extent. By this means the flow rate is adjusted through intermediate exchangers 16 relative to the flow rate through core 11, independently of the rotational speed of the shaft line of shafts 320, 321.

FIG. 5 shows the retraction of blades 300 on impeller 30 which sucks up the sodium of toroid 21 to adjust the flow rate through intermediate exchangers 16 relative to the flow rate through core 11. In the context of the invention, a proportion at least of the blades of other impeller 31 may, of course, be retracted in an alternative or cumulative manner.

FIG. 6 presents an optimised embodiment to improve the efficiency of the thermal stratification in the space of height H separating the two horizontal portions 1500, 1510 of the upper and lower walls 150, 151 and thus to improve the natural convection Cr (residual flow) of the primary sodium in stopped operation of nuclear reactions. A cut 15000 is provided in the horizontal portion 1500 of the upper wall 150 under each exchanger. The exchange area of the exchangers 25 dedicated to the discharge of residual power is entirely placed inside the hot collector.

Outlet window 250 is positioned just beneath horizontal portion 1500 of upper wall 150. A functional clearance j3 between cut 15000 of upper wall 150 and exchanger 25 allows differential movement between these components.

The advantages of this lay out during operating mode of discharging the residual power from the core 11 (stopped as well as pumping system 3), are the following:

since the outlet window 250 of the secondary exchanger 25 is placed just under the horizontal portion 1500 of the upper wall 150, the cold sodium coming out of this exchanger 25 in operation descends more easily to the cold collector 14 since one of the walls 150 has already been surmounted, and this without mixing with the sodium from the hot collector 12, in other words, the hydraulic path during stopped operation under natural convection is improved,

the sodium passes through the horizontal portion 1510 of the lower wall 151 via cuts 15100 made under the exchanger dedicated to the discharge of residual power and via the holes constituted by the functional clearances between the lower wall and the intermediate exchangers and the functional clearance between the wall of the step and vessel of the reactor.

The height H of the space between horizontal portions 1500, 1510 of the two walls 150, 151 is relatively important (of the order of two metres) to enable correct stratification. The distance between the vertical portions 1501, 1511 of the two walls is small (of the order of several centimetres).

The space of height H is in communication with the hot collector 12 and the cold collector 14 through the following functional clearances:

j1 defined between horizontal portions 1500, 1501 of both walls and vessel 13. This functional clearance j1 is of the order of several centimetres and enables the differential movements between the components (walls 150, 151 and vessel 13) to be taken up,

j2 defined in the ducts between intermediate exchangers 16 and system 321 supporting pumps 3 and walls 150, 151. This functional clearance j2 is of the order of several centimetres and enables the differential movements between the components (walls 150, 151 and intermediate exchangers 16, and between walls 150, 151 and pumps 3) to be taken up,

j3 defined in the ducts between exchangers 25 dedicated to removing residual power and horizontal portion 1500 of upper wall 150. As mentioned above, for the sodium exiting these exchangers 25 to return easily to cold collector 14, additional cuts 15100 are made vertically in horizontal portion 1510 of the lower wall.

To dimension precisely the separation device in a given configuration, those skilled in the art will see to it that the communication spaces do not have sections of passage too important with a large hydraulic diameter in order to form an efficient physical separation.

The purpose of the walls is in fact to mark a physical limit between areas 12, 14 where the flows have high velocities: hot collector 12 and cold collector 14, with a calm area where a thermal stratification has to establish itself without there being any necessity to have sealing. As a function of the application of the invention, specific lay outs may be made. Whatever the case, the functional clearances j1, j2 and j3 and the height H between the horizontal portions 1500, 1510 of the two walls of the separation device are previously determined so as to, during normal operation, take up differential movements between the walls 150, 151, exchangers 16, 25, pump 3 and vessel 13 and to make it possible to establish during normal operation a thermal stratification of the primary sodium in the space defined between the horizontal portions of the two walls 150, 151 and to reduce, in case of an unexpected stop of a pumping group 30 or 31 (when they are decoupled), the mechanical stress applied to the walls and due to the portion of the primary sodium flow passing between said clearances. The thermal stratification thereby determined thus consists in a way in providing a sufficiently important volume over the height between the two walls 150, 151 and reducing the parasitic flow of primary sodium between hot area 12 and cold area 14.

By way of example, an order of magnitude of the flow area between walls and collectors 12, 14 is given here. For this evaluation, the functional clearances at the level of the communications j1, j2 and j3 are estimated at around 5 cm:

functional clearance j1 between the vessel 13 and portions of wall 1500, 1510: with a vessel of diameter of the order of some fifteen metres the total section is 2.3 m²,

functional clearance j2 between intermediate exchanger 16 or pump 3 and portions of wall 1500, 1510: with six exchangers 16 and three pumps 3 which require a flow area approximately equal to a ring the internal of diameter equal to that of the intermediate exchangers and of the pumps, i.e. approximately 2 metres, and therefore the width of the ring is clearance j2, the section is approximately 2.5 m²,

functional clearance j3 between the exchanger for discharging residual power 25 and the horizontal portion 1500 of the upper wall 150: with six exchangers 25 of around a meter diameter, the section is ˜1 m².

The total section of passage of the horizontal portion of the upper wall is around 6 m².

This total estimate is valid for upper wall 150. Since lower wall 151 is not traversed by exchangers 25, which are dedicated to removing the residual power, only cuts 15100 are made in the horizontal portion 1510 of this wall. These cuts 15100 preferably have a hydraulic diameter equivalent to the other cuts, i.e. a diameter of approximately 0.10 m. The number of these cuts 15100 is preferably such that their total section is at least equal (in terms of order of magnitude) to the total section created by functional clearance j3 around residual power removal exchangers 25.

In the embodiment illustrated, since this section is of the order of 1 m², at least twenty or so cuts 15100 are provided under each exchanger 25 dedicated to the discharge of residual power.

Whatever the case, the section of passage through the walls with cuts 150, 151 is, in order of magnitude, satisfactory for all of the following different operations:

it must be sufficiently large so that the walls 150, 151 do not undergo too high mechanical stress in the event of total unexpected stoppage of a pump group 30 or 31 when these two groups are mechanically independent (decoupled). Indeed, in the case of a reactor with a rated power of the order of 3600 MW, the sodium flow rate in normal operation is of the order of approximately 22.5 m³/s. Thus, for example, in the case of an untimely stoppage of a pump group 30 or 31 supplying intermediate exchangers 16, when these two groups are mechanically independent a portion of the sodium flow continues to flow in intermediate exchangers 16, and the other portion through clearances j1, j2, j3 between components 3, 16, 25, 13 and walls 150, 151. The distribution between the two flows depends on the relative load losses between intermediate exchangers 16 and walls 150, 151. An estimate of these load losses potentially leads to approximately 70% of the flow passing through clearances j1, j2, j3, or some 16 m³/s. The average speed between the cuts of walls 150, 151 and the components is therefore 2.7 m/s. This is a low speed, and does not lead to major mechanical stresses on walls 150, 151,

it is sufficiently large so as not to break the thermal stratification, in other words maintain a vertical temperature profile and highest and lowest temperatures that can always be corrected during normal operation by automatic control of the pumps and maintained in stopped operation,

during normal operation, to limit parasitic flows through the holes, the hydraulic diameter must be small. The sections of passage in the walls 150, 151 are preferably of very long shape with a width of around 5 cm. In this case, the hydraulic diameter is substantially equal to twice the width, i.e. 10 cm. With such a diameter related to the diameter of a vessel of a reactor according to the invention of approximately 15 m, the relative value of the hydraulic diameter is therefore equal to approximately 0.1/15, i.e. less than 0.7%.

FIG. 6 shows an embodiment which has been optimised to measure the thermal gradient in the internal space between horizontal portions 1500, 1510 of wall 150, 151. The represented temperature acquisition means are constituted here by several booms 6 immersed in the sodium and traversing both horizontal portions 1500, 1510 of both walls 150, 151. On this/these booms 6 thermocouples 60 are positioned the function of which is to detect the temperature of the sodium at different altitudes in the internal area of height H between walls 150, 151. Knowledge of the vertical temperature profile, combined with digital processing, enables changes of the thermal gradient to be monitored, and the sodium flow traversing core 11 to be controlled by the sodium flow traversing intermediate exchangers 16.

In normal operation, as seen above, it is sought to make these two flow rates identical. Under these conditions, the area of height H between the two walls 150, 151, constitutes an area without flow or with flows with low velocity enabling the establishment of a thermal stratification.

It is this thermal stratification that serves as separation between the two hot 12 and cold 14 collectors.

The measurement of this thermal stratification by the thermocouples or temperature sensors 60 fixed at different altitudes to the boom(s) or by another method makes it possible if required to adjust the relative flow between the flow traversing core 11 and the flow traversing intermediate exchangers 16.

As shown in FIG. 5, retraction of the blades of one of the two impellers 30, 31 of a pump 3 may then be used as a means of adjusting these flow rates.

The efficiency of the thermal stratification may be evaluated by the Richardson number defined by the following equation:

Ri=g(Δρ/ρ)H/V²

Where:
g is the acceleration due to gravity;
Δρ/ρ is the relative density variation;
Δρ=ρ_{cold}−ρₕₒₜ;
ρ_{cold} is the density of the cold fluid;
ρₕₒₜ is the density of the hot fluid;
ρ is the average density of the fluids;
H is a dimension characteristic of the volume, typically the height of the volume,
V is the arrival velocity of the fluid in the volume.

The Richardson number Ri thus characterises the ratio between the density or gravitational forces (Δρ g H) with the forces of inertia (ρ V²). If the forces of inertia are greater than the gravitational forces, Ri will be less than one and the forced convection prevails, there is no stratification. If the gravitational forces are greater than the forces of inertia, Ri will be greater than one, which signifies that there is a stratification that establishes itself inside the volume.

In a volume comprising inlets and outlets of hot and cold liquid, it is considered that there is stratification if the dimensionless Richardson number is greater than one.

In the specific case under examination, the volume to be considered is the space of height H located between the two horizontal portions 1500, 1510 of walls 150, 151. Since, in normal operation, the flows traversing core 11 and intermediate exchangers 16 are equal, there is no flow in this space of height H, and therefore the speeds are zero. In reality, there can be slight flow because the two walls being cut by means of functional clearances j1, j2, j3, low flow velocities appear through said clearances.

Evaluation of the Richardson Number Ri in a Reactor According to the Invention:

Power of the reactor: 3600 MW.

Core inlet temperature (cold temperature): ˜390° C.

Core outlet temperature (hot temperature): ˜540° C.

Rated sodium flow ˜22.5 m³/s

Density of the hot Na: ˜821 kg/m³

Density of the cold Na: ˜857 kg/m³

Relative density variation: ˜4.3%.

Acceleration due to gravity: 9.81 m/s².

Relative dimension of the volume (corresponding to the height H between the two walls 150, 151): ˜2 m.

Section of passage in the walls 150, 151 due to the presence of clearances j1, j2, j3: ˜6 m².

If an important imbalance of temporary flow of 10% is estimated between the flow traversing core 11 and the flow traversing intermediate exchangers 16, this signifies that there is potentially a 10% flow of the rated flow which passes through functional clearances j1, j2, j3 i.e. around 2.25 m³/s.

With a section of around 6 m², the velocity is thus around equal to 0.37 m/s.

This being so, Richardson number Ri is roughly equal to 6. Since this number is greater than one, the flow in the space between walls 150, 151 of height H is indeed stratified.

Measurement of the level of this stratification therefore enables the relative flow rates between the flow traversing core 11 and the flow through intermediate exchangers 16 to be readjusted by appropriate regulation, preferably by retracting the blades of one of impellers 30, 31. This appropriate regulation can also be accomplished by an additional pumping means installed in toroid 21 to suck up a proportion of the sodium from intermediate exchangers 16.

FIG. 7 represents a preferred arrangement of pump 3 with two impellers 30, 31 according to the invention, with its drive motor 33 and axial displacement mechanism 34 of shaft 324 retracting the impeller's blades.

In this arrangement, drive motor 33 of the shaft line is positioned above the reactor's covering slab 24 and axial displacement control mechanism 34 to retract the blades is itself positioned above drive motor 33. For reasons of simplification of this mechanism a reliable mechanism of the screw-nut or hydraulic jack type may be used. Also for reasons of simplification of its installation, shaft 320 may be positioned in the centre of the shaft which is rotated by motor 33.

An SFR reactor of the integrated type according to the EFR project under consideration, according to patent application WO 2010/0557720, may have a vessel diameter of the order of 17 to 18 m.

An SFR reactor of the same power as the EFR project under consideration, but the architecture of which is based on the present invention (represented in FIG. 1), including six intermediate exchangers 16, six second exchangers 25 and three centrifugal rotodynamic pumps 3 with double impellers 30, 31, may have a vessel diameter of between 15 and 16 m.

Other improvements may be made without however going beyond the scope of the invention.

Thus, for example, if the illustrated embodiment advantageously provides, for a given pumping means 3, a double-impeller pump to accomplish the pumping from hot area 12 to the cold area (impeller 30), and the pumping from cold area 14 to the hot area (impeller 31), two separate pumps can also be provided, i.e. ones which are not coupled to one another when operating. With such an embodiment the fluid communication of the inlet of the pump pumping the primary sodium from the hot area to the cold area with the toroid according to the invention is retained.

1. An SFR nuclear reactor of the integrated type, comprising a vessel adapted to be filled with sodium and inside of which are provided a core, pumping means for the flow of the primary sodium, first heat exchangers, known as intermediate exchangers, adapted to discharge the power produced by the core during normal operation from second heat exchangers adapted to discharge the residual power produced by the core while stopped when the pumping means are also stopped, a separation device defining a hot area and a cold area in the vessel, including:
a separation device is constituted of two walls each with a substantially vertical portion provided surrounding the core and a substantially horizontal portion, the substantially horizontal portions being separated from each other by a height and the space defined above the horizontal portion of the upper wall forming the hot area whereas the space defined below the horizontal portion of the lower wall forms the cold area and the substantially horizontal portions are provided with clearances in relation to the vessel,
intermediate exchangers arranged substantially vertically with clearances in first cuts made in each horizontal portion of the wall of the separation device so as to localise their outlet windows below the horizontal portion of the lower wall,
pumping means with variable flow divided into two groups hydraulically in series, one provided below the horizontal portion of the lower wall for the flow of the sodium from the cold area to the hot area through the core, the other to pump the sodium from the hot area to the cold area through the intermediate exchangers,
temperature acquisition means provided in the space defined between the horizontal portions of the two walls in being spread out along a substantially vertical axis to determine in real time the thermal stratification in said space,
automatic control means connected on the one hand to the temperature acquisition means and on the other hand to the two pump groups, to modify if necessary the flow of at least one pump group in order to maintain a satisfactory level of stratification during normal operation,
second exchangers arranged substantially vertically above the cold area,
means to enable the natural convection of the primary sodium from the second exchangers to the cold area when the core and the pumping means are also stopped,
a reactor in which all of the clearances and the height between the horizontal portions of the two walls of the separation device are previously determined so as to, during normal operation, take up differential movements between the walls, exchangers and vessel and to make it possible to establish during normal operation a thermal stratification of the primary sodium in the space defined between the horizontal portions of the two walls and to reduce, in case of an unexpected stop of a single pumping group, the mechanical stress applied to the walls and due to the portion of the primary sodium flow passing in the said clearances.
characterised in that:
each of the outlet windows of the intermediate exchangers is surrounded in an enclosure in fluid communication with a pipe shaped into a toroid,
each of the inlets of the pump group which pumps the sodium from the hot area to the cold area through the intermediate exchangers is also in fluid communication with the toroid, such that the primary sodium originating from the hot area and exiting from the intermediate exchangers flows through the toroid and is then directed to the cold area by the said pump group.

2. A nuclear SFR reactor of the integrated type according to claim 1, in which both variable flow rate pump groups in hydraulic series are mechanically independent of one another, and each consists of rotodynamic pumps, the drive shaft of which extends vertically over the entire height of the vessel, traversing the covering slab and the horizontal portions of both walls of the separation device, which are arranged appreciably vertically with clearances, where the clearances between the structure supporting the pumps and both walls of the separation device are also determined beforehand such that, in normal operation, they take up the differential displacements between them and the vessel, and to enable thermal stratification of the primary sodium to be established in normal operation in the space defined between the horizontal portions of both walls and, in the event of an untimely stoppage of a pump group, to limit the mechanical forces which are applied to the walls, due to the proportion of the primary sodium flow passing through the said clearances.

3. A nuclear SFR reactor of the integrated type according to claim 1, in which the two variable flow rate pump groups in hydraulic series are mechanically dependent, and consist of at least one double-impeller centrifugal rotodynamic pump, a first impeller of which positioned with its inlet to suck up the primary sodium axially into the toroid, and with its outlet to drive the primary sodium into the cold area, and the second impeller, installed on the same drive shaft line as the first impeller, and positioned with its inlet to suck up the primary sodium into the cold area, and its outlet to drive it towards the core.

4. A nuclear SFR reactor of the integrated type according to claim 3, including at least one means to adjust the flow rate of primary sodium through the core relative to the flow rate through the intermediate exchangers, independently of one another, and of the speed of rotation of the drive shaft line of both impellers.

5. A nuclear SFR reactor of the integrated type according to claim 4, in which the means for adjusting the flow rate consist of one/some additional pumping means, separate from the electromechanical pump(s) with two impellers, and the inlet of which is/are in fluid communication with the toroid, where the sum of the flow rates of primary sodium supplied by the additional pumping means and the impeller of the double-impeller pump are approximately equal to the flow rate traversing the intermediate exchangers.

6. A nuclear SFR reactor of the integrated type according to claim 5, in which the additional pumping means are constituted by a rotodynamic pump and/or an electromagnetic pump.

7. A nuclear SFR reactor of the integrated type according to claim 4, in which:
the drive shaft line of the pump's two impellers includes at least two coaxial shafts which can be displaced axially relative to one another, where the lower end of one of the shafts supports at least a proportion of the impeller's blades, whereas the lower end of the other shaft supports the other portion of the impeller;
the means for adjusting the flow rate consist of the drive shaft, to the lower end of which the proportion (at least) of the impeller's blades are attached, and the axial displacement of which relative to the other drive shaft allows the proportion at least of the blades to be retracted.

8. A nuclear SFR reactor of the integrated type according to claim 7, in which the mechanism for controlling movement of the shaft allowing the proportion at least of the blades of an impeller to be retracted is positioned above the drive motor of the shaft line, which is itself positioned above the covering slab.

9. An SFR reactor of the integrated type according to claim 8, including six intermediate exchangers, six second exchangers, and three double-impeller centrifugal rotodynamic pumps.
